(19) United States
(12) Patent Application Publication
(10) Pub. No.: US 2006/0139841 A1
(43) Pub. Date: Jun. 29, 2006

(54) Electromagnetic relay control

(76) Inventor: Francis Delaporte, Osny (FR)

Correspondence Address: FOLEY & LARDNER LLP, 777 EAST WISCONSIN AVENUE, SUITE 3800, MILWAUKEE, WI, 53202-5308, US

(21) Appl. No.: 10/536,712

(22) PCT Filed: Nov. 28, 2003
(86) PCT No.: PCT/FR03/03524

§ 371 Date: Dec. 14, 2005

(30) Foreign Application Priority Data
Nov. 28, 2002 (FR) 02/14942

(51) Int. Cl. H01H 47/00

(52) U.S. Cl. 361/160

(57) ABSTRACT

The process for controlling an electromagnetic relay comprises at least one contact, controlled by a voltage or current supply. In accordance with the invention the control is modulated according to the voltage or current supply, to the contacting voltage required to close the contact of the relay, and to the maintaining voltage which is sufficient to maintain this closure.

The invention concerns the area of electromagnetic relays. It relates in particular to the relays used in automobile vehicles.

In order to be active, the coils of electromagnetic relays are supplied with power directly by a battery or any other power source provided to control a contact.

This is particularly the case with electromagnetic relays fitted to the various electrical or electronic service boxes (BSE) of automobile vehicles. These are for example engine monitoring boxes (BSM), intelligent service boxes (BSI) or even central cabin units (UCH) or engine units (USM).

These boxes are of limited volume and generally have a certain number of electromagnetic relays with other electrical or electronic components, the assembly being intended to ensure calculation and switching functions.

In order to control an electromagnetic relay, in particular in order to close the contact, it must be supplied with sufficient power, i.e. a so-called contact-contacting voltage must be applied to its coil. This voltage is substantially greater than the so-called maintaining voltage required simply to maintain it in the contacted state. In order to open the contact a voltage is applied which is necessarily lower than the so-called release voltage.

The voltage applied across an electromagnetic relay coil generates a current exciting an electromagnet which closes the contact of the relay or keeps it closed. The coil then dissipates thermal energy, of the order of several watts, by the Joule effect. The contact itself, when closed, permits passage of an electric current and also dissipates thermal energy, slightly lower than the previous energy level.

In order to control the relays, the battery voltage of the vehicle is currently applied in the boxes. This voltage varies over time.

In order to overcome this disadvantage the document U.S. Pat. No. 5,930,104 proposes a device permitting the control voltage of a relay to be maintained at a minimum level required for its operation, and control thereof to be suspended when this voltage is greater than the maximum threshold admissible by its coil.

However, a BSE box can comprise up to about ten relays having various characteristics. The thermal constraints imposed on the service boxes by manufacturers have become very severe. Since the density of the installed components continues to increase, these constraints are more and more difficult to respect and, for obvious reasons of safety, it is not possible to suspend the control of certain BSE box relays if their coil can no longer sustain the supply voltage.

An object of the invention is to provide a control process permitting the relays to operate in acceptable thermal and operational conditions and to do so in a confined environment as described above.

In accordance with the invention the process for controlling electromagnetic relays, controlled by a current or voltage supply, is characterised in that the control is modulated according to the current or voltage supply and to the contacting voltage which is sufficient to close the contacts of the relay, and is modulated according to the current or voltage supply and to the maintaining voltage which is sufficient to maintain this closure.

By this process the coil of the relay dissipates only a level of thermal energy reduced to the minimum necessary both to close the contacts of the relay and to maintain this closure. It is no longer necessary to suspend the control of the relay in the event of excessively high supply voltage.

The invention also relates to a device for controlling an electromagnetic relay from a voltage source. It is characterised in that it has a module for adapting the power supply of the relay and a control module to control the power supply-adapting module.

It is thus possible to supply the relay with levels of energy just necessary during contacting and during maintaining of its contacts, which makes it possible to obtain a reduction in the thermal dissipation of its coil.

The control module preferably has means to control the duration of operation of the power supply-adapting module during contacting of the contacts, a duration at the end of which it must control the maintaining of the contacts. These means take account in particular of the type of relay controlled.

It is also preferable that the control module has a module for detecting micro power cuts in order, at the end of a micro power cut in the supply voltage of the relays, to control, upon closure, the relays if they were closed before the micro power cut.

It is another preferable feature that the control device comprises an oscillator connected to the power supply-adapting module, which comprises a calculation function and a pulse duration modulation (MID) function for the supply voltage. In this way different contacting and maintaining commands are obtained by simply changing the cyclic ratio (RC) of the MID function.

The energy dissipated by the coil thus controlled depends on the ratio RC imposed by the MID function. In particular, at equal supply voltage, the cyclic ratio RC imposed by the calculation function during maintaining is lower than that imposed during contacting of the relay.

The invention will be better understood with the aid of the following description and the accompanying drawings in which:

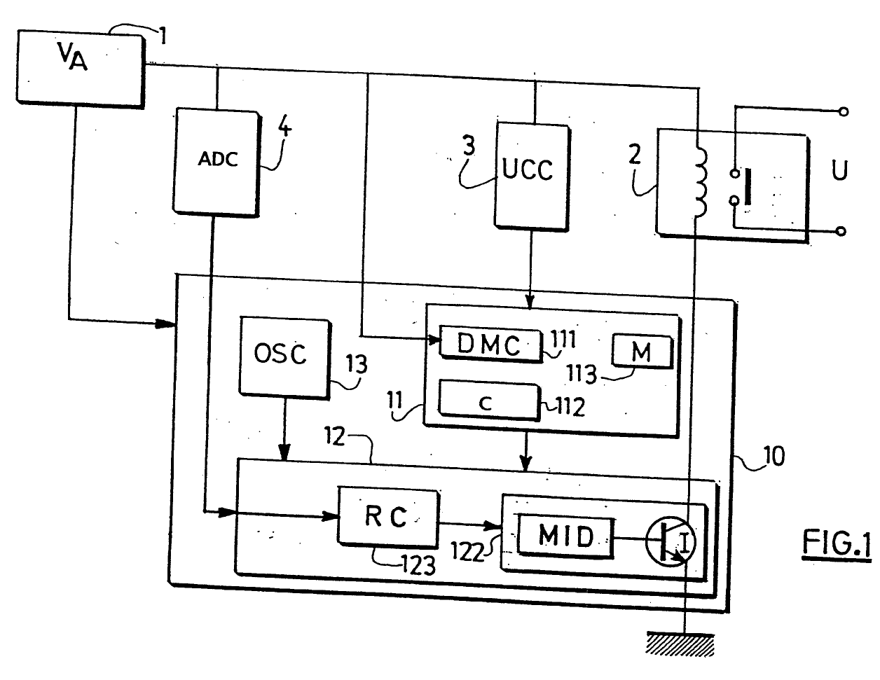

FIG. 1 illustrates a functional block diagram of a control device for a relay in accordance with the invention,

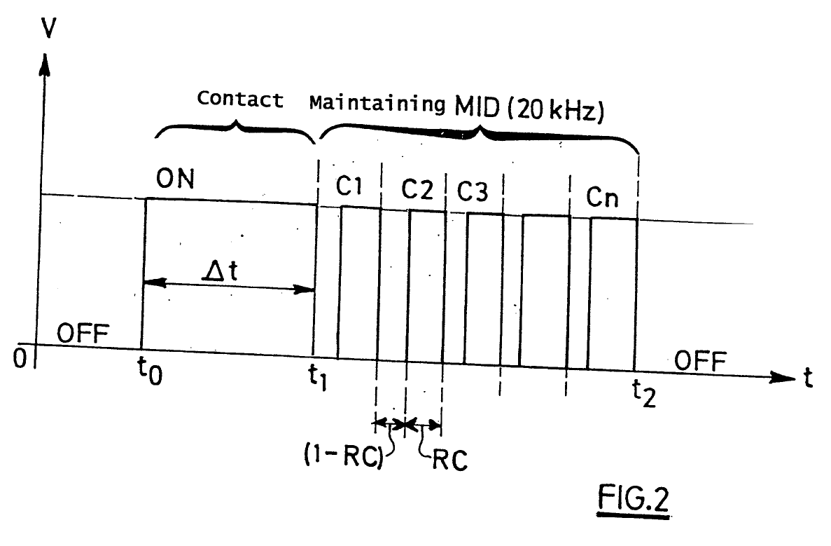

FIG. 2 illustrates a typical timing diagram of the control applied to a relay by the device of the invention,

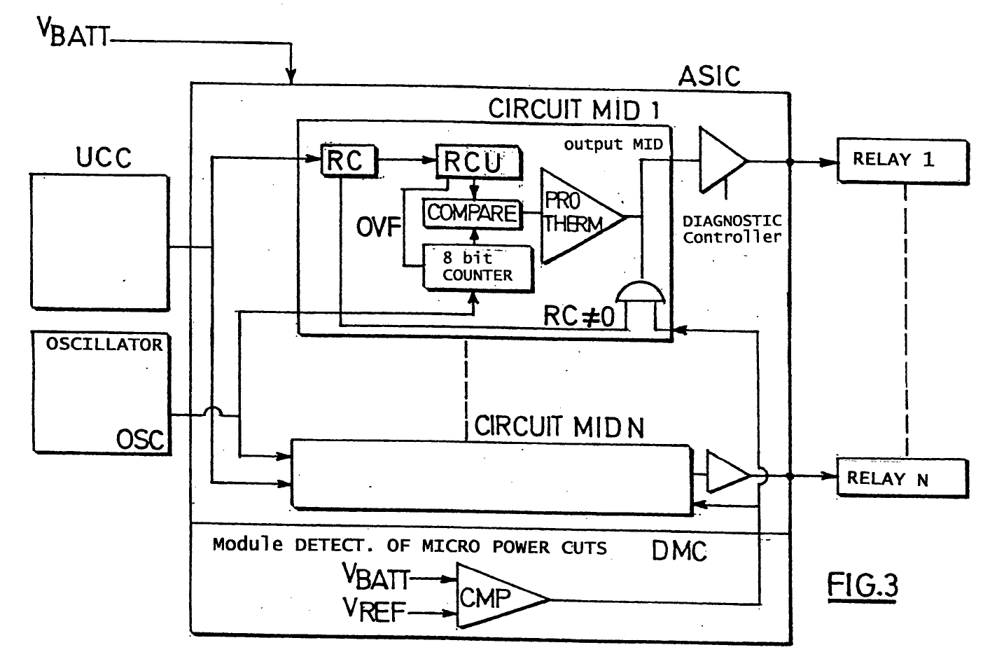

FIG. 3 illustrates an example of implementation of the invention for a service box,

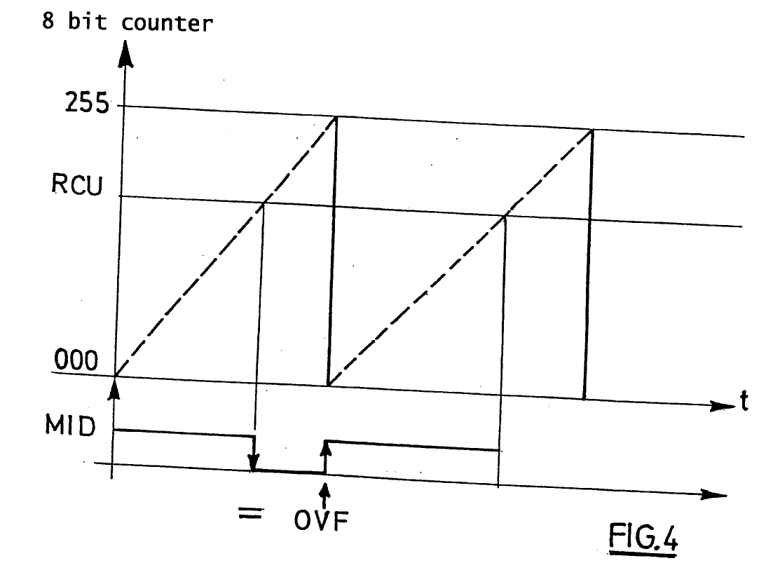

FIG. 4 illustrates a timing diagram of the operation of the MID in the previous implementation.

With reference to FIG. 1, the continuous supply 1, in this case a battery, of which the voltage V_{A} can vary, depending on its use at a particular moment, between 9 and 16 volts, supplies:

a relay 2 when a serviceable voltage U is cut,

an analogue digital converter 4 supplying the momentary value V_{A},

a control-command unit 3 for the serviceable voltage U and

a device 10 for control of the relay 2.

The device 10 comprises for this purpose a control module 11 which receives a command issued by the control-command unit 3 and which controls a power supply-adapting module 12. It also comprises an oscillator 13 which delivers a frequency of 20 kHz to the module 12.

The module 11 comprises a circuit 111 for detecting micro power cuts, a clock 112 and a memory 113 containing the characteristics of the relay 2.

The module 12 comprises a means 122 for pulse duration modulation, designated by the initials MID or by the abbreviation PWM for “pulse width modulation”. It receive its instructions from a calculation and control means 123 by its MID circuit [lacuna] the switch I when the power supply of the relay 2 is cut.

The operation of the device will now be explained.

The switch I being open, the relay 2 is at rest, contact open (it will be assumed at this point that this is a “working” contact relay). In order to close the contact of the relay 2, the control-command unit 3 sends a closure command to the device 10, more precisely to its control module 11.

The module 10 reads the characteristics of the relay in its memory 113. These are the contacting voltage V_{C}, the maintaining voltage V_{M} to be respected and the minimum duration over which the voltage V_{C} must be applied to contact the contact securely. This duration is represented by Δt in FIG. 2.

The module 11 then sends a closure command (OF) from the relay 2 to the power supply-adapting module 12. At the same time, it triggers its clock 112 for a time Δt, at the end of which it sends to the module 12 a maintaining command (OM) for the relay 2. The commands OF and OM also comprise the characteristics of the relay 2 and are processed in the calculation means 123 jointly with the value of the level of the battery voltage V_{A}, increased by the analogue digital converter 4. V_{A} is a function of time V_{A}=V_{A}(t). The calculation means 123 thus calculates the cyclic ratio RC of the pulse duration modulation means 122 in the following manner.

In a first version (see FIG. 2),

between to and t1, in contacting phrase, thus during Δt:
RC=1
after t1, in maintaining phase, and if a release command has not intervened (at t2 in FIG. 2)
RC=V_{M}/V_{A}(t).

Thus the maintaining command of the relay is modulated over time according to the power supply and the maintaining voltage when only maintaining is necessary. The relay is supplied with power under an average voltage equal to V_{M} which reduces its thermal dissipation by the quantity:
Q=(V²_{A}−V²M)/R
assuming that R represents the resistance of the coil of the relay.

In a second more sophisticated version;

between to and t1, during Δt
RC=V_{C}/V_{A}(t)

between t1 and t2
RC=V_{M}/V_{A}(t)
with similar consequences to those previously seen in the dissipation of energy from the relay.

If the battery delivers a sufficiently stable voltage V_{A} it is possible to simplify and admit into the calculations that the voltage V_{A}(t) is equal to a constant average value V_{A}moy.

The means 123 transforms the commands OF and OM by changing the cyclic ratio RC value for the means 122. In order to open the relay 2, the control module sends a release command to the module 12, thus to the means 123, which simply cancels the cyclic ratio RC which has the effect of opening the switch I.

Upon a micro power cut being detected by the circuit 11 the module 11 sends a closure command OF to the module 12 if the relay 2 was subject to an OF or OM command. This makes it possible to avoid the risk of not being able to close the relay, the maintaining voltage being insufficient for that.

Another embodiment will be described hereinunder with reference to FIG. 3. The circuit ASIC (“Application Specific Integrated Circuit”), the circuit UCC (control-command unit) and the oscillator OSC permit implementation of the process of the invention.

The control-command unit (UCC) has the means 123 and those of the module 11 except that provided by the micro power cut detection circuit 111.

The module 11 is integrated in the circuit ASIC as well as N means 122 for pulse duration modulation MID, intended to control N relays. Each module corresponding to MID1, MIDi . . . , MIDN, has a register RCU containing a number of 8 bits equal to 256 times the cyclic ratio RC. The oscillator OSC of frequency F increments an 8 bit counter of which the value is compared to the content of the RCU register. In the event of equality, with reference to FIG. 4, the output signal MIDi serving to control a relay i is set to zero. In the event of overflow (OVF) of the 8 bit counter, this same signal is set to 1. An MID circuit of frequency F times 256 has thus been produced.

If F 25 kHz, the cycle of the MID is about 10 milliseconds.

Using a comparator CMP, a circuit DMC compares the battery voltage with a reference function in order to detect micro power cuts. When a micro power cut occurs the output of the module MID i is set to 1 so as to short-circuit the MID i circuit if this circuit is in the phase of maintaining the relay i, information being available in the register RC.

1. Process for controlling electromagnetic relays (2) comprising at least one contact, controlled by a voltage or current supply (1), characterised in that the control is modulated according to the voltage or current supply and to the contacting voltage which is sufficient to close the contact of the relay (2), and is modulated according to the voltage or current supply and to the maintaining voltage which is sufficient to maintain this closure.

2. Device (10) for controlling electromagnetic relays (2) from a voltage source (1) implementing the process of claim 1, characterised in that it has a module (12) for adapting the power supply of the relay and a control module (11) to control the power supply-adapting module.

3. Device as claimed in claim 2, wherein the control module (11) has means (112) to control the duration of operation of the power supply-adapting module (12) during contacting of the contacts, a duration at the end of which it must control the maintaining of the contacts.

4. Device as claimed in one of claims 2 and 3, wherein the control module (11) has a module (111) for detecting micro power cuts.

5. Device as claimed in one of claims 2 to 4, comprising an oscillator (13) connected to the power supply-adapting module (12), which comprises a calculation means (123) and a means (122) for pulse duration modulation (MID) of the supply voltage.

6. Device as claimed in one of claims 2 to 5, comprising a memory (113) storing the characteristics of the relay (2).

7. Specific integrated circuit (ASIC) comprising at least one pulse duration modulation means (122), the modulation means (122) being controlled by a control-command unit (3) programmed for modulating the power supply of at least one electromagnetic relay 2 according to the process of claim 1.

8. Circuit as claimed in claim 7, characterised in that it further comprises a circuit (DMC) for detecting micro power cuts.

9. Circuit as claimed in claim 8, wherein the micro power cut detector circuit, upon occurrence of a micro power cut, controls a contacting voltage on the relays with controlled maintaining voltage.
